(19) United States
(12) Patent Application Publication
(10) Pub. No.: US 2004/0066183 A1
(43) Pub. Date: Apr. 8, 2004

(54) Active magnetic sensor for electronic braking systems

(76) Inventors: Peter Lohberg, Friedrichsdorf (DE); Wolfgang Fey, Niedernhausen (DE); Michael Zydek, Frankfurt/Main (DE); Stephan Bruggemann, Frankfurt/Main (DE)

Correspondence Address: Gerlinde M Nattler, Continental Teves Inc, One Continental Drive, Auburn Hills, MI, 48326, US

(21) Appl. No.: 10/432,482

(22) PCT Filed: Oct. 24, 2001
(86) PCT No.: PCT/EP01/12268

(30) Foreign Application Priority Data
Nov. 22, 2000 (DE) 100 58 138.2
Sep. 24, 2001 (DE) 100 46 949.7

(51) Int. Cl. G01P 3/48

(52) U.S. Cl. 324/166

(57) ABSTRACT

The present invention describes an active magnetic sensor, in particular for detecting the rotational behavior of a wheel, comprising a magneto-electric transducer (2) that is electrically connected to a modulator (5), a current source subassembly (4) controlling the signal current output at the sensor output (k₃, k₄), said sensor being characterized by an undervoltage monitoring circuit (10) which monitors the electric signal prevailing at sensor output (k₃, k₄) with respect to whether a voltage value falls below a first predetermined threshold voltage (V_{U}) and which controls the signal current output at sensor output (k₃, k₄) in dependence on the result of this monitoring action by influencing the current source sub-assembly (4).

### TECHNICAL FIELD

The present invention generally relates to sensors and more particularly relates to an active magnetic sensor for detecting the rotational behavior of a wheel.

### BACKGROUND OF THE INVENTION

Active sensors for the acquisition of rotational speeds in motor vehicle anti-lock systems (ABS) and driving dynamics control systems (ESP) are generally known in the art. In German patent application DE 196 34 175 A1 a generic sensor for sensing the wheel rotational speed is described, which is connected to an electronic brake control unit (ECU) by way of a two-pole current interface for transmitting wheel rotational speed data. A corresponding ‘active sensor’ is fed electrically by way of a signal interface connected to the electronic brake control unit.

It is known that an undesirably high ohmic resistance, e.g. caused by corrosion at the plug couplings, may develop over time during operation of wheel speed sensors in the area of the electric lead-in wires between the electronic control unit and the sensor. This resistance impairs the proper operation of the wheel speed sensor. Detecting corresponding faults is frequently obstructed e.g. when high-ohmic contacts occur only temporarily.

### BRIEF SUMMARY OF THE INVENTION

An object of the present invention is to disclose a wheel rotational speed sensor that permits detecting line faults by way of an electronic control unit connected to the sensor.

This object is achieved by an active magnetic sensor, in particular for detecting the rotational behavior of a wheel, comprising a magneto-electric transducer that is electrically connected to a modulator, a current source sub-assembly comprising one or more current sources and controlling the signal current that is output at the sensor output (k₃, k₄), comprising an undervoltage monitoring circuit which is connected to sensor output (k₃, k₄), and monitors the electric signal prevailing at sensor output (k₃, k₄) with respect to whether a voltage value falls below a first predetermined threshold voltage (V_{U}), and which controls the signal current output at sensor output (k₃, k₄) in dependence on the result of this monitoring action by influencing the current source sub-assembly.

An active sensor in the wording of the present invention refers to a sensor with electronic components for evaluating the electric signal of a magneto-electric transducer (Hall sensor or magneto-resistive sensor), with the typically active electronic components being supplied electrically by way of the signal output(s) of the sensor.

In an arrangement for detecting the rotational speed of a motor vehicle wheel, a so-called encoder that may be a toothed steel wheel or a periodically magnetized ring is normally connected to a wheel bearing or in any other fashion. As it rotates the encoder induces the magneto-electric transducer magnetically so that said produces a periodic electric signal, e.g. with a period number corresponding to the number of teeth passing by the sensor. According to a particularly favorable embodiment that will be described hereinbelow, square-wave wheel speed pulses are produced from the electric periodic signal and sent to an electronic control unit by way of a current interface.

The sensor of the invention may include two or three output lines for connection to an electronic control unit. The sensor may also be configured as a so-called ‘single-wire sensor’ when one of the electric lead-in wires extends as a ground connection via the vehicle body. Preferably, the active sensor of the invention includes a two-wire current interface.

The active magnetic sensor of the invention permits transmitting wheel speed data to a control unit of an electronic brake system by way of a current interface. To this end, the current source sub-assembly is preferably used to modulate rotational speed current pulses onto the signal current, said pulses being square-wave pulses in particular. It is particularly preferred that the pulses are current pulses having an invariably defined length so that the rotational speed data is indicated by the distance between the pulses.

An undervoltage monitoring circuit takes influence on the current at the output of the sensor when an undervoltage was detected by comparing the current voltage to a predetermined threshold value, the said comparison being suitably executed with a comparator. When the voltage falls below the predetermined threshold value, the undervoltage monitoring circuit will preferably initiate the output of a characteristic signal pattern that differs significantly from the signals that occur in normal operation. This signal especially concerns a low constant current that lies below the amplitudes of the transmittable pulses.

Favorably, additional current pulses for the transmission of additional data may also be modulated on the signal current by way of the current source subassembly between the rotational speed current pulses. It is appropriate for these additional signals to have an amplitude lower than the wheel speed pulses.

The magnetic sensor preferably also comprises an observing circuit corresponding to the arrangement in the above-mentioned DE 196 34 715 A1, which—in dependence on the voltage at the sensor output—introduces additional signals onto the rotational speed signal, especially by influencing the current source sub-assembly provided in the sensor or by influencing the existing modulator. This enables the magnetic sensor to react to voltage modulations input from the outside via the ‘output’ for the purpose of transmitting signals to the sensor. This is appropriate especially when the sensor shall be requested by an electronic control unit to send defined additional information between one of the subsequent wheel speed pulses by way of the current interface.

In case the transmission of additional signals that can be externally activated or influenced is not desired, or additional data transmission is not even desired at all, the active sensor may also be designed without an observing circuit.

Preferably, the magneto-electric transducer is arranged in a housing unit isolated from the sensor module.

However, it is also possible that the magneto-electric transducer is arranged inside the sensor module.

In an alternative embodiment, the above-described magnetic sensor of the invention and at least one electronic control unit which is a component part of an integrated electro-hydraulic brake control unit.

### BRIEF DESCRIPTION OF THE DRAWINGS

FIG. 1 is a view of an active sensor of the state of the art.

FIG. 2 is an active sensor according to the invention.

FIG. 3 is a representation of the signal course at the output of an active sensor.

### DETAILED DESCRIPTION OF THE PREFERRED EMBODIMENTS

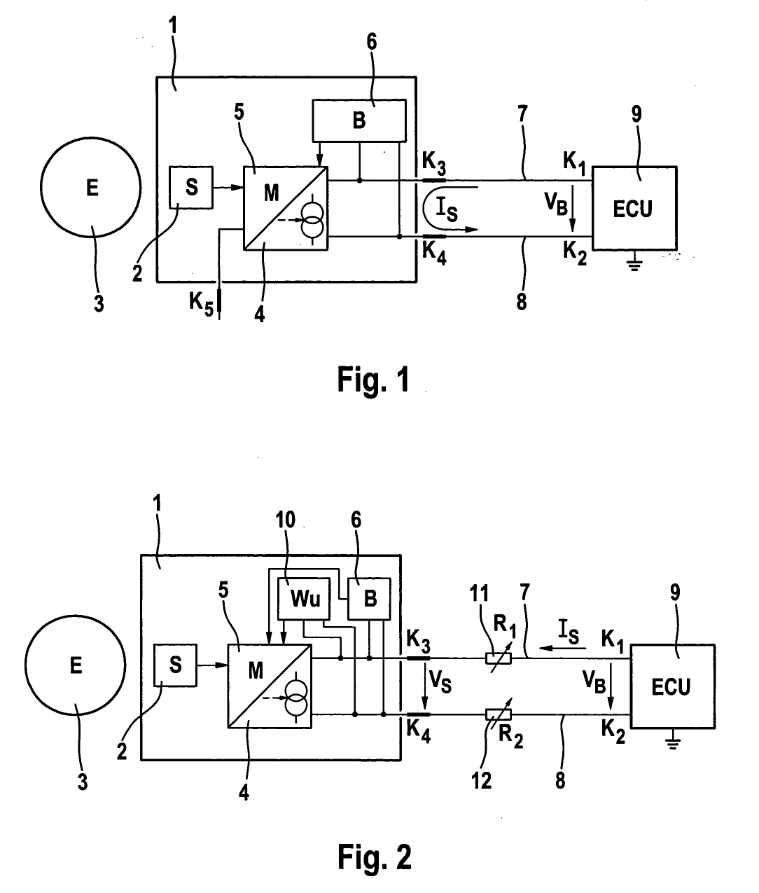

FIG. 1 shows a schematic view of the essential function elements of an active sensor corresponding to DE 196 34 715 A1. A sensor module 1 and an electronic control unit of an ABS controller (ECU) 9 are interconnected by way of a two-wire line 7, 8. Encoder 3 is a permanent-magnetic encoder with a ring-like closed sequence of magnetized north/south pole areas. Encoder 3 is magnetically coupled via an air slot to a magneto-resistive bridge circuit 2 that is arranged inside the sensor module 1.

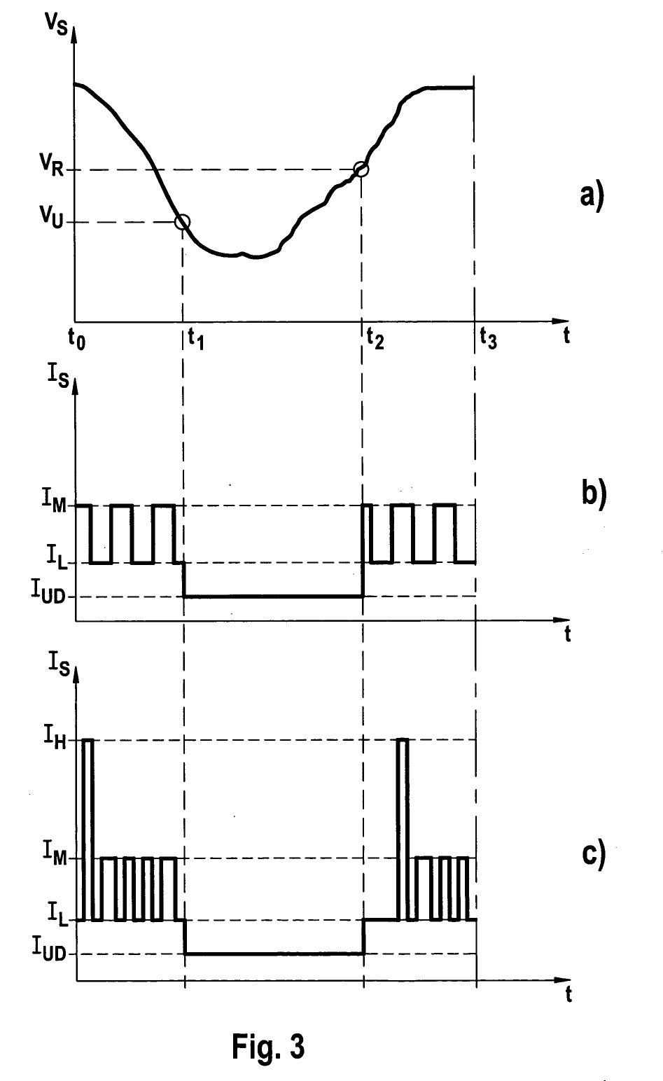

An operating voltage V_{B} is needed to operate the sensor module 1, which is provided by the ECU at terminals K₁ and K₂, the latter being connected to terminals K₃ and K₄ (sensor output) by way of a sensor line 7, 8. A signal current I_{S} controlled by the sensor module flows to the ECU by way of terminals K₃ and K₄ of the sensor module. Wheel rotational data is impressed on said signal current in the form of square-wave current pulses, with the signal current alternating between two current levels in the clock of the pulse train predetermined by encoder 3. This pulse train is illustrated in partial picture b) of FIG. 3 within the periods t₀-t₁ or also t₂-t₃ for a sensor without additional signal interface.

In a sensor with additional data interface, additional data is transmitted to the signal current according to partial picture c) of FIG. 3 in the form of individual bits, for example, about brake lining wear, the air slot or the direction of rotation, between the rotational speed pulses. These additional bits are modulated in the form of individual current pulses in per se known Manchester coding so that e.g. signal patterns are produced within the periods to t₀-t₁ and t₂-t₃ as illustrated in partial picture c) in FIG. 3. As will be explained in detail in the following, the wheel rotational speed pulses have a higher amplitude in sensors equipped with a device for the transmission of additional information than in wheel rotational speed sensors without a corresponding device.

In the arrangement shown in FIG. 1, an observing circuit 6 is integrated in sensor module 1, said observing circuit being connected to the output that provides connection between the sensor module 1 and ECU 9. Observing circuit 6 is connected to terminals K₃ and K₄ so that the signal voltage can be tapped for the purpose of communication with the electronic control unit. Observing circuit 6 monitors and controls modulator 5 in dependence on the signal condition on the connecting lines 7, 8. This permits controlling the acceptance or processing of the information or signals supplied via the additional port K₅ in dependence on predetermined criteria, signal conditions or time allowed, being sent by the electronic control unit to the sensor by way of the current interface. For this purpose, the observing circuit 6 acts on a modulator 5, which e.g. adds a sequence of additional signals between the wheel rotational speed pulses when demanded by the electronic control unit g.

An active sensor according to the invention is illustrated in FIG. 2, the sensor comprising a voltage monitoring circuit 10 in addition to the sensor shown in FIG. 1. Voltage monitoring circuit 10 checks the terminals K₃ and K₄ by comparison with a predetermined threshold value. When the voltage falls below the predetermined threshold value for the supply voltage furnished by the ECU due to an undesirably high resistance in the area of the lead-in wires 7, 8, for example, circuit 10 will initiate the output of a constant current level U_{D} that is below the current levels of the signal pulses occurring in normal operation.

The undervoltage monitoring arrangement may be designed so that the terminal voltage in relation to an internal voltage reference is compared by means of a comparison window in order to switch over between V_{U} and V_{R}. In case of a voltage of V_{U} the internal current source in current source unit 4 with the value I_{L}=7 ma is adjusted to half the current (3.5 ma), and the other current sources contained therein, which are provided for the generation of current values of 14 ma and 28 ma, are disconnected.

FIG. 3 represents in partial picture c) the mode of operation of the voltage monitoring circuit 10 by way of the signal variation at the sensor output of a sensor according to FIG. 2 at terminals K₃ and K₄. This sensor includes a three-level interface with standardized current level nominal values, which are fixed in consideration of appropriate tolerance ranges with I_{L}/I_{M}/I_{H}=7 ma/14 ma/28 ma.

Partial picture b) shows the signal by way of the example of an active sensor without additional signal function, said sensor having a two-level interface with the fixed current level nominal values I_{L}/I_{M}=7 ma/14 ma.

Partial picture a) shows in an exemplary view the time variation of the supply voltage prevailing at terminals K₃ and K₄ in the event of a drop of the sensor supply voltage V_{S}. When the ECU 9 provides a supply voltage with the voltage V_{B}, V_{B} will reduced with an increase of the lead-in wire resistances 11 and 12 to V_{S}=I_{S}×(R₁+R₂) . As soon as V_{S}, as illustrated in partial picture a), reaches or drops below a bottom threshold value V_{U} at time t₁, the signal current in the partial pictures b) and c) changes over to the constant diagnosis level I_{UD} and will remain at this level until a voltage V_{R} is exceeded at time t₂ (partial picture a)), thereby effecting the return to the original signal current pattern. Suitable values of V_{U} lie in a range of less than 3 to 5.5 volt approximately. The current I_{UD} can be fixed to a nominal value in the range of about 1 to 6 ma, especially to a nominal value in the range of 3 to 4 ma approximately.

The said switching hysteresis is brought about because the threshold V_{R} initiating the return to the normal signal transmission is higher than threshold V_{U}. Appropriate values of V_{R} range between 5.5 and 7 volt approximately.

1. Active magnetic sensor, in particular for detecting the rotational behavior of a wheel, comprising a magneto-electric transducer (2) that is electrically connected to a modulator (5), a current source sub-assembly (4) comprising one or more current sources and controlling the signal current that is output at the sensor output (k₃, k₄),
characterized by an undervoltage monitoring circuit (10) which is connected to sensor output (k₃, k₄), and monitors the electric signal prevailing at sensor output (k₃, k₄) with respect to whether a voltage value falls below a first predetermined threshold voltage (V_{U}), and which controls the signal current output at sensor output (k₃, k₄) in dependence on the result of this monitoring action by influencing the current source subassembly (4).

2. Magnetic sensor as claimed in claim 1,
characterized in that the current source sub-assembly is used to modulate rotational speed current pulses onto the signal current which represent a motion information of an encoder (3) that is passed by the transducer.

3. Magnetic sensor as claimed in claim 2,
characterized in that the current source sub-assembly is used to modulate additional current pulses onto the signal current in the time periods between the rotational speed current pulses.

4. Magnetic sensor as claimed in at least one of claims 1 to 3,
characterized in that said sensor comprises an observing circuit (6) which effects an introduction of additional signals into the rotational speed signal in dependence on the voltage at the sensor output (k₃, k₄).

5. Magnetic sensor as claimed in at least one of claims 1 to 4,
characterized in that the current source (4), the modulator (5) and the monitoring circuit (10) and, as the case may be, the observing circuit (6) are grouped in a sensor module (1).

6. Magnetic sensor as claimed in at least one of claims 1 to 5,
characterized in that the undervoltage monitoring circuit (10) after detection of a voltage below the first threshold voltage (V_{U}) triggers an undervoltage current signal for a defined period of time.

7. Magnetic sensor as claimed in claim 6,
characterized in that the undervoltage monitoring circuit (10) is so configured that the undervoltage current signal produced after detection of an undervoltage will be terminated only when the voltage lies above another threshold voltage (V_{R}), with the further threshold voltage exceeding the first threshold voltage.

8. Magnetic sensor as claimed in at least one of claims 1 to 7,
characterized in that the condition of the undervoltage is signaled by outputting a constant current (I_{UD}) at the sensor output.

9. Arrangement comprising an active magnetic sensor as claimed in at least any one of claims 1 to 9 and at least one electronic control unit (9),
characterized in that the voltage at the output (k₃, k₄) is reduced by the control unit (9) for the purpose of signal transmission, and this signal is registered in the active magnetic sensor by an observing circuit (6).
